(19) United States
(12) Patent Application Publication
(10) Pub. No.: US 2020/0042907 A1
(43) Pub. Date: Feb. 6, 2020

(54) METHODS, SYSTEMS, APPARATUSES AND DEVICES FOR FACILITATING MANAGEMENT OF A PLURALITY OF SPACES

(71) Applicant: Brian Anichini, Chicago, IL (US)

(72) Inventor: Brian Anichini, Chicago, IL (US)

(21) Appl. No.: 16/230,681

(22) Filed: Dec. 21, 2018

Related U.S. Application Data
(60) Provisional application No. 62/713,828, filed on Aug. 2, 2018.

(51) Int. Cl. G06Q 10/02; G06Q 10/10; H04W 4/021; H04W 4/33; H04L 29/08

(52) U.S. Cl. CPC G06Q 10/02; G06Q 10/1095; H04L 67/12; H04W 4/33; H04L 67/32; H04W 4/021

(57) ABSTRACT

A system for facilitating management of a plurality of spaces based on at least one space characteristic and at least one occupant characteristic is disclosed. The system may include a communication device configured for receiving a request from a user device. Further, the request may include at least one requested space characteristic indicator and at least one requested occupant characteristic indicator. Further, the communication device may be configured for receiving a user location indicator from the user device. Further, the communication device may be configured for transmitting a plurality of space indicators to the user device. Further, the system may include a processing device configured for analyzing the request and the user location indicator. Further, the system may include a storage device configured for retrieving the plurality of space indicators corresponding to a plurality of spaces based on the analyzing.

### FIELD OF THE INVENTION

Generally, the present disclosure relates to the field of data processing. More specifically, the present disclosure relates to methods, systems, apparatuses and devices for facilitating management of a plurality of spaces.

### BACKGROUND OF THE INVENTION

The field of finding suitable spaces is technologically important to several industries, business organizations and/or individuals. For example, the space may include homes, apartments, hotel rooms, exhibition halls, etc.

Existing techniques for finding suitable spaces are deficient with regard to several aspects. For instance, current technologies do not allow users to easily find spaces for their specific needs. Furthermore, current technologies are not designed to automatically obtain information about various parameters of the available spaces. Moreover, current technologies do not provide easy access to service providers near the available spaces.

Therefore, there is a need for improved methods, systems, apparatuses and devices for facilitating management of a plurality of spaces that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating management of a plurality of spaces, in accordance with some embodiments. Accordingly, the method may include a step of receiving, using a communication device, a request from a user device. Further, the request may include at least one requested space characteristic indicator and at least one requested occupant characteristic indicator. Further, the method may include receiving, using the communication device, a user location indicator from the user device. Further, the user device may include a location sensor configured for generating the user location indicator based on a location of the user device. Further, the method may include analyzing, using a processing device, the request and the user location indicator. Further, the method may include retrieving, using a storage device, a plurality of space indicators corresponding to a plurality of spaces based on the analyzing. Further, the method may include transmitting, using the communication device, the plurality of space indicators to the user device.

Further disclosed herein is a system for facilitating management of a plurality of spaces, in accordance with some embodiments. Accordingly, the system may include a communication device configured for receiving a request from a user device. Further, the request may include at least one requested space characteristic indicator and at least one requested occupant characteristic indicator. Further, the communication device may be configured for receiving a user location indicator from the user device. Further, the user device may include a location sensor configured for generating the user location indicator based on a location of the user device. Further, the communication device may be configured for transmitting a plurality of space indicators to the user device. Further, the system may include a processing device configured for analyzing the request and the user location indicator. Further, the system may include a storage device configured for retrieving the plurality of space indicators corresponding to a plurality of spaces based on the analyzing. Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

FIG. 1 is an illustration of an online platform consistent with various embodiments of the present disclosure.

FIG. 2 is a block diagram of the system for facilitating management of a plurality of spaces based on at least one space characteristic and at least one occupant characteristic, in accordance with various embodiments of the present disclosure.

FIG. 3 is a flowchart of a method of facilitating management of a plurality of spaces based on at least one space characteristic and at least one occupant characteristic in accordance with some embodiments.

FIG. 4 is a flowchart of a method of facilitating management of a plurality of spaces available via a plurality of external services in accordance with some embodiments.

FIG. 5 is a flowchart of a method of obtaining sensor information in accordance with some embodiments.

FIG. 6 is a flowchart of a method of determining one or more associated services from one or more service providers in accordance with an exemplary embodiment.

FIG. 7 is a flowchart of a method of managing a service request in accordance with an exemplary embodiment.

FIG. 8 illustrates a flowchart of a method to facilitate searching of available spaces by a user, in accordance with the embodiments.

FIG. 9 illustrates a flowchart of a method to display one or more filming locations to a user, in accordance with some embodiments.

FIG. 10 illustrates a flowchart of a method to identify an event and display one or more appropriate spaces, in accordance with some embodiments.

FIG. 11 illustrates a flowchart of a method to facilitate the user to procure a ride service based on a detected confirmed event, in accordance with some embodiments.

FIG. 12 is a block diagram of a computing device for implementing the methods disclosed herein, in accordance with some embodiments.

Furthermore, the drawings may contain text or captions that may explain certain embodiments of the present disclosure. This text is included for illustrative, non-limiting, explanatory purposes of certain embodiments detailed in the present disclosure.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of management of a plurality of spaces, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

In an embodiment, a platform to facilitate managing of a plurality of spaces may be disclosed. The platform may facilitate displaying of available spaces to a user, and may be called as “Crashere”. In an instance, the spaces may include homes, wedding spaces/locations, rehearsal spaces, bachelor parties/bachelorette party spaces, campgrounds, houseboats, business meeting spaces, and market research spaces.

Further, the platform may facilitate filtering of specifications, prices, dates, amenities, and proximity of all home-sharing apps collectively. Further, the platform may include a concert/event filter that may allow calculation of proximity of a space to a specific music venue/event a user may be visiting. Further, the platform may include unique filters including themes such as former homes of current actor/sports player, filmed locations (spaces where movies may have been filmed), treehouse/tent options, and so on. Further, the platform may allow the user to lease, or rent, or otherwise acquire wedding space locations and lodging, spaces for recording or rehearsals of bands, market research/focus group locations, filming shot locations vacancies, (former filmed locations like movie locations, former/current film star homes, celebrity, sports star/politicians former homes, supposedly haunted locations, and so on. Further, the platform may include filter to find one or more spaces including holiday themes, such as extreme decorations like X-mas, Jewish holidays, Halloween, and so on.

Further, the platform may include a filming location module that may allow the user to filter spaces available for filming, with or without available lodging. The platform may also provide spaces based on filters such as bachelor/bachelorette parties, swinger's events, arcade/game room themed houses, and spaces including a fire pit/gazebo. The platform may also include a separate search module for entire apartments homes private rooms or basement rooms.

Further, the platform may include a wedding module to filter spaces such as hotels, resorts, waterfronts, rural mansions, and nature spaces in general areas which may be used for hosting weddings. Further, the platform may allow a user to reserve wedding and reception spaces, along with additional accommodation in a single reservation.

Further, the platform may allow the user to search for band rehearsal/recording spaces with or without lodging option, market research/focus group/mach trial spaces with or without lodging. Accordingly, the platform may allow the user to search for homes, garages, and event/rehearsal spaces in a general area. The platform may contain the collective module that equates all the major home-sharing sites specs, locations, price, and amenities. Further, the platform may include a concert/event module that may allow the user to search for required spaces near an event, such as music festival, carnival, and so on.

Further, the platform may include a property type filter, which may allow the user to search for houses, apartments, bed and breakfast inns, tree houses, outdoor tents, garages, filmed locations (spaces where movies may have been filmed), former actors, comedians, athlete's former homes, pinball/game room type homes, campers/RVs, 4 star hotels, cottages, cabins, and so on. Further, the platform may include a rooms and beds filter and room accessibility filter, including options such as step free, illuminated entrance, wide hallway, elevator, grab bars in bathroom elevator or chairlift, and so on.

Further, the platform may include an amenities filter which may allow the user to choose amongst required amenities such as kitchen, heating, air conditioning, washer, dryer, office space crib, TV, self-check in, smoke detector, carbon monoxide detector, and so on. The platform may also include a facilities filter and a house rules filter. The facility filter may include options such as ethnic themes, free park on site, gym and hot tub, vacant spaces with no furniture or bedding, number of electrical outlets, home recording studios, outdoor/indoor home theater, coy ponds or fish tanks, spaces cleaned with organic (non toxic) cleaning products, spaces with humidifier/room air filter (for users with allergies) option filter, spaces with 100% solar power, and so on. Further, the platform may include a close to filter, and may describe if a space is close to facilities such as hospitals, theatres, recreational marijuana stores, AA or substance abuse self-help meeting centers, and so on. Further, the house rules filter may include options such as events welcome and pets allowed, smoking and/or drinking allowed or not, and so on.

Further, the platform may include a filter to search for spaces that may include paid/free shuttle and bar bus info to events like sports, concerts, comic cons, racing events, and so on.

Further, the platform may include a bedding filter allowing the user top search for spaces with different types of beds such as posturepedic beds, water beds, wall beds, and so on.

Further, the platform may include a filter to search for spaces with bike rental, electronic bikes, Segway®, and dune buggy add on options, car rental options, and so on

Further, the platform may allow the user to search for exclusive bachelor/bachelorette party spaces with close strip clubs, adult novelty stores, drag queen shows, hangover/IV clinics calculated closest to the said space, and so on. Further, the exclusive bachelor/bachelorette party spaces may include Pedialyte® stock fridges.

Further, the platform may include a filter to search for spaces with housesitting providers, and may also allow the user to search for house sitters, such from external databases such as databases associated with services like Housecarers®.

Further, the platform may include a search filter allowing the user to search for closest to public transport a space, along with an illuminated map outlined around the said space. Further, the filter may allow the user to search for spaces providing pre-loaded public transport cards.

Further, the platform may allow the user to search for pre-stored or utilized concert/event spaces. Further, the platform may allow the user to search for shared spaces for events, such as music concerts sharing module with events such as Lollapalooza®, also allowing the user to search for spaces included in ticketing packages associated with the event.

Further, the platform may include a veteran search filter consisting of specific spaces owned by veterans or used by veterans, with veteran id numbers.

Further, the platform may allow the user to sign in through external login methods through API, such as Facebook®, Twitter®, Instagram®, LinkedIn®, and so on.

Further, the platform may allow the user to customize the platform through overall interests like music genre, comedy, music fests, sporting events, comic conventions, horse racing, wine tasting, boating, skiing, art galleries, fishing, and so on to search for spaces. Further, the overall interests may also be retrieved from one or more social media platforms.

Further, the platform may allow the user to access and navigate the platform through a multi-language voice activated search mechanism option.

Further, the platform may promote artists such as musicians such as with musician-centered promos on one or more databases, along with tickets to one or more events of the artists, such as concerts of musicians, and spaces around the one or more concerts.

Further, the platform may allow the user to avail pre-parking services, such as through one or more external databases associated with services like SpotHero®, to reserve one or more parking spaces near a reserved space and/or event.

Further, the platform may include food delivery referral options, that may allow the user to pre order food and/or groceries to a space before arrival.

Further, the platform may also include a multi payment user interface, supporting multiple options including PayPal®, Venmo®, Square®, credit cards, Apple Pay®, Google Pay®, cryptocurrency, personal checks, and so on. Further, the platform may also include a filter to search for spaces that may allow for split payments (payments in multiple instalments), and split payments from two or more sources. Further, the platform may allow the user to avail a veteran discount while making reservation for a space using a veteran id number.

Further, the platform may also include rideshare services credit discounts through referral.

Further, the platform may allow a user to list a space for one or more users to reserve, along with a minimum and maximum price dictated by supply and demand in a general area of the space. Further, the overall price may not be ranged, but set in precise numbers.

Further, the platform may allow the user to avail referral points (such as referral points that may be used on the platform, or externally, such as Microsoft® reward points) by sharing referral code, such as on social media websites, which may be used by the user to avail discounts, such as while reserving spaces, or for ridesharing services.

Further, the platform may allow the user to pre-pay referral points to ride services at a flat rate to deter price surging in a busy area.

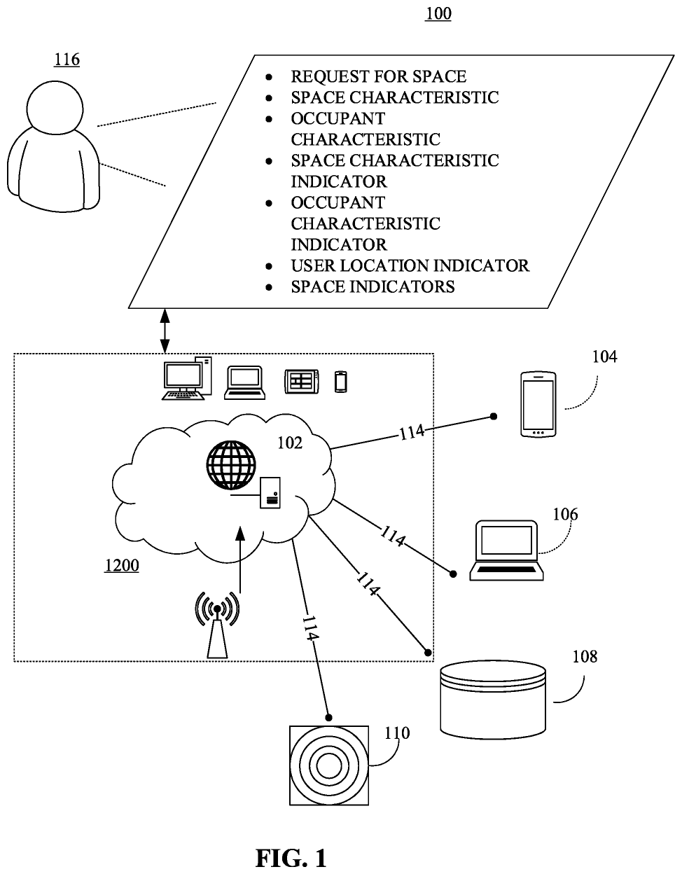

FIG. 1 is an illustration of an online platform 100 consistent with various embodiments of the present disclosure. By way of non-limiting example, the online platform 100 to facilitate management of a plurality of spaces may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform 100.

A user 116, such as the one or more relevant parties, may access online platform 100 through a web based software application or browser. The web based software application may be embodied as, for example, but not be limited to, a website, a web application, a desktop application, and a mobile application compatible with a computing device 1200.

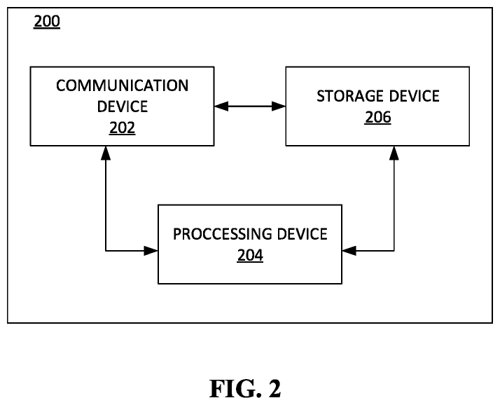

FIG. 2 is a block diagram of the system 200 for facilitating management of a plurality of spaces based on at least one space characteristic and at least one occupant characteristic, in accordance with various embodiments of the present disclosure. Further, a space characteristic may refer to an attribute of a space that may describe a usability of the space. For instance, a space characteristic may include a type of space, such as an apartment, a gym, a conference hall, and so on. Further, a space characteristic may include additional features relating to one or more facilities, or amenities available in the space. For instance, a space may include a hotel room, including amenities such as an attached balcony, room heater, and so on. Further, an occupant characteristic may refer to a descriptor of an occupant, which may differentiate a search criteria particular to a space that the occupant may be searching. For instance, age and gender of the occupant may be occupant characteristics. Additional examples of occupant characteristics may include one or more areas of interest of the occupant. The system 200 may include a communication device 202 configured for receiving a request from a user device. Further, the request may include at least one requested space characteristic indicator and at least one requested occupant characteristic indicator. Further, the space characteristic indicator may include a descriptor (or a code) associated with a space characteristic. For instance, one or more space characteristic indicators may be related to one or more space characteristics, such as type of spaces including apartments, hotel rooms, meeting rooms, wedding spaces, filming locations, and so on. Further, the communication device 202 may be configured for receiving a user location indicator from the user device. Further, the user location indicator may include a location descriptor, describing a location of the occupant. Further, the user device may include a location sensor configured for generating the user location indicator based on a location of the user device. Further, the communication device 202 may be configured for transmitting a plurality of space indicators to the user device. Further, the plurality of space indicators may include one or more descriptors related to one or more spaces determined to be appropriate for the occupant based on the one or more space characteristic indicators and the occupant characteristic indicators. For instance, the one or more space indicators may be related to one or more of spaces such as hotel rooms, apartments, and so on.

Further, the system 200 may include a processing device 204 configured for analyzing the request and the user location indicator. Further, the system 200 may include a storage device 206 configured for retrieving the plurality of space indicators corresponding to a plurality of spaces based on the analyzing.

In some embodiments, the communication device 202 may be further configured for transmitting the request to a plurality of external databases (such as the databases 108). Further, each external database may be configured for storing data representing at least one space of the plurality of spaces. Further, the plurality of external databases may include databases configured for storing data representing one or more spaces of the plurality of spaces. For instance, the plurality of external databases may be associated with a plurality of space sharing services, such as Airbnb®, Hotels.com®, and so on. Further, the communication device 202 may be configured for receiving at least one space indicator from at least one external database.

In some embodiments, the processing device 204 may be further configured for determining at least one sensor identifier associated with at least one sensor (such as the sensors 110) corresponding to at least one space of the plurality of spaces. Further, the at least one sensor corresponding to at least one space of the plurality of spaces may include a sensor configured to capture one or more space characteristics related to the at least one space of the plurality of spaces. For instance, the sensor configured to capture one or more space characteristics of a space may include an indoor camera installed in the space that may capture one or more amenities in the space, such as an indoor pool. Further, for instance, the at least one sensor corresponding to at least one space of the plurality of spaces may include an IOT device, such as a temperature sensor configured to capture one or more space characteristics, such as presence of one or more amenities in the space, including thermostats, air purifiers, and air conditioning, and so on. Further, the at least one sensor identifier may include one or more descriptors particular to the at least one sensor, such as one or more of an IP address, MAC address, and so on. Further, the determining may be based on the analyzing. Further, the processing device 204 may be configured for comparing one or more of the at least one requested space characteristic indicator and the requested occupant characteristic indicator with one or more of at least one current space characteristic indicator and at least one occupant characteristic indicator respectively. Further, the retrieving may be based on the comparing. Further, the communication device 202 may be configured for transmitting a command to the at least one sensor based on the determining. Further, the communication device 202 may be configured for receiving one or more of at least one current space characteristic indicator and at least one occupant characteristic indicator.

Further, the storage device 206 may be configured for storing one or more of at least one current space characteristic indicator and at least one occupant characteristic indicator.

Further, the communication device 202 may be configured for receiving a request comprising at least one space characteristic indicator, and occupant characteristic indicator from the user device. Further, the communication device 202 may be configured to receive (in real-time) at least one current space characteristic indicator from at least one sensor corresponding to the at least one space of the plurality of spaces. Further, the processing device 204 may be configured for comparing the at least one space characteristic indicator, and occupant characteristic indicator, and the at least one current space characteristic indicator and determining at least one space indicator based on the comparing. Further, the communication device 202 may be configured for transmitting at least one space indicator based on the determining to the user device.

For instance, a space characteristic indicator received from the user device may include a heated indoor pool. Further, a current space characteristic indicator may be received from a camera and a thermistor corresponding to a space in real time. Further, the space characteristic indicator and the current space characteristic indicator may be compared to determine that the space includes a heated indoor pool. Accordingly, the space indicator corresponding to the space may be transmitted to the user device.

In some embodiments, the at least one requested space characteristic indicator may include at least one indoor amenity indicator and at least one outdoor amenity indicator. Further, the at least one indoor amenity indicator may include one or more descriptors related to one or more amenities located indoors in the space, such as an indoor pool, an air purification system, a thermostat, and so on. Further, the at least one outdoor amenity indicator may include one or more descriptors related to one or more amenities located outdoors in the space, such as an outdoor gazebo. Further, the at least one sensor may include at least one indoor sensor associated with the at least one indoor amenity and at least one outdoor sensor associated with the at least one outdoor amenity.

In some embodiments, the request further may include a theme indicator associated with a theme. Further, retrieving the plurality of space indicators may be based on the theme indicator. For instance, the theme indicator may include details of an indoor theme related to a space, such as a Halloween theme. Accordingly, a plurality of space indicators related to the Halloween theme may be retrieved. In another instance, the theme indicator may include specific requirement such as a decorated Christmas tree. Accordingly, a sensor (camera) at a space may be queried in real-time to determine availability of a decorated Christmas tree at the space.

In some embodiments, the request may include an event indicator. Further, the event indicator may include descriptors related to an event that may describe the event. For instance, the event indicator may include one or more of a date of the event, a type of the event, such as a music festival, a sports event, a carnival and so on. Further, the processing device 204 may be configured for identifying an event location based on the event indicator. Further, retrieving the plurality of space indicators may be based on the identifying of the event location. For instance, space indicators related to one or more spaces in a vicinity of the event may be retrieved.

In some embodiments, the event indicator may be associated with a calendar appointment corresponding to the user device. Further, the calendar appointment may include an event time indicator. Further, retrieving the plurality of space indicators may be based on the event time indicator. For instance, a calendar appointment corresponding to the user device may include an event indicator corresponding to an event, such as a type of event including an office meeting and/or a market research meeting. Further, the calendar appointment may include additional event indicators, such as a number of participants of the meeting, a location of the meeting including a name of the city, area or building where the event may be scheduled to take place, and so on. Further, the calendar appointment may include an event time indicator, such as a date and time of the event, a duration of the event and a time when the event may start. Accordingly, a plurality of space indicators may be retrieved based on the event indicator and the event time indicator. For instance, a plurality of space indicators related to one or more appropriate conference rooms based the event indicator and event time indicator, including the number of members participating in the meeting, location of the meeting, time of the meeting, and so on may be retrieved from one or more relevant databases housing a list of available conference rooms, such as hotel databases.

In some embodiments, the processing device 204 may be further configured for identifying at least one associated service based on the analyzing of the request. Further, the communication device 202 may be configured for transmitting each of the user location indicator and at least one space location indicator to at least one associated service provider server. Further, the at least one space location indicator may be associated with at least one space of the plurality of spaces. Further, the communication device 202 may be configured for receiving at least one associated service offer from the at least one associated service provider server. Further, the communication device 202 may be configured for transmitting the at least one associated service offer to the user device. Further, an associated service may include a supplementary service that the occupant may be able to avail in addition to the space. In some embodiments, the at least one associated service may include one or more of a ride sharing service, a public transportation service, a food delivery service, a costume delivery service and a laundry service. Further, the at least one associated service provider server may include at least one database of the at least one associated service provider. For instance, an associated ride service may be identified based on the analyzing of the request. Accordingly, a user location indicator describing occupant location, along with a space location indicator may be transmitted to an associated ride service server. Further, the communication device 202 may be configured to receive an associated service offer from the associated ride service server, including a time of ride service, details of a vehicle for the ride service, an estimated cost of the ride service, and so on. Further, the communication device 202 may be configured for transmitting the associated service offer to the user device.

In some embodiments, the communication device 202 may be further configured for receiving at least one service request from the user device. Further, the at least one service request may correspond to the at least one associated service. Further, the communication device 202 may be configured for transmitting the at least one service request to the at least one associated service provider server.

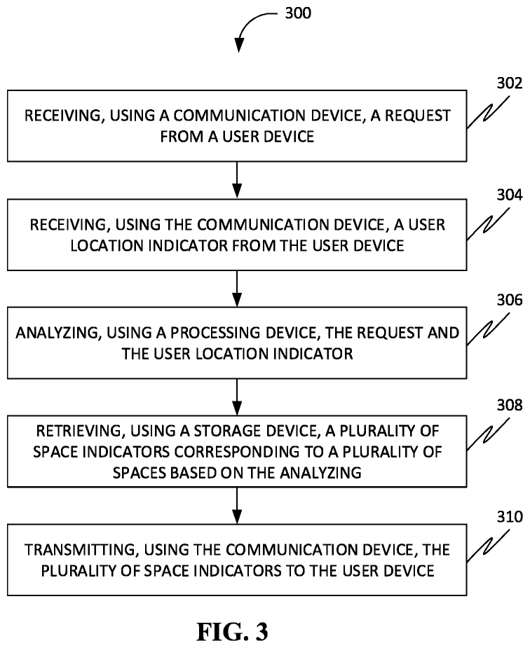

FIG. 3 is a flowchart of a method 300 of facilitating management of a plurality of spaces based on at least one space characteristic and at least one occupant characteristic in accordance with some embodiments. At 302, the method 300 may include receiving, using a communication device (such as the communication device 202), a request from a user device. Further, the request may include at least one requested space characteristic indicator and at least one requested occupant characteristic indicator.

In some embodiments, the request further may include a theme indicator associated with a theme.

Further, at 304, the method 300 may include receiving, using the communication device, a user location indicator from the user device. Further, the user device may include a location sensor configured for generating the user location indicator based on a location of the user device.

Further, at 306, the method 300 may include analyzing, using a processing device (such as the processing device 204), the request and the user location indicator. At 308, the method 300 may include retrieving, using a storage device (such as the storage device 206), a plurality of space indicators corresponding to a plurality of spaces based on the analyzing. Further, at 310, the method 300 may include transmitting, using the communication device, the plurality of space indicators to the user device.

In some embodiments, the request (at 302) may include an event indicator. Further, the method 300 may include identifying, using the processing device, an event location based on the event indicator. Further, retrieving the plurality of space indicators may be based on the identifying of the event location.

In further embodiments, the event indicator may be associated with a calendar appointment corresponding to the user device. Further, the calendar appointment may include an event time indicator. Further, retrieving the plurality of space indicators may be further based on the event time indicator.

In some embodiments, the request further may include a theme indicator associated with a theme. Further, retrieving the plurality of space indicators may be based on the theme indicator.

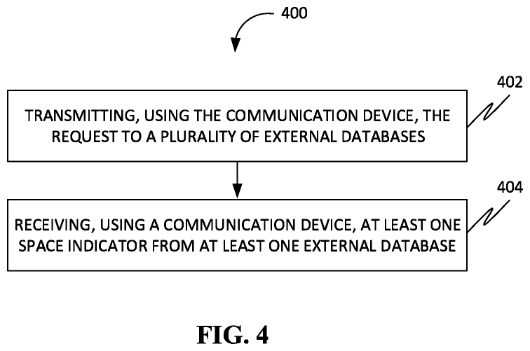

FIG. 4 is a flowchart of a method 400 of facilitating management of a plurality of spaces available via a plurality of external services in accordance with some embodiments. At 402, the method 400 may include transmitting, using the communication device, the request to a plurality of external databases. The plurality of external databases may be associated the plurality of external services. Further, each external database may be configured for storing data representing at least one space of the plurality of spaces. Further, at 404, the method 400 may include receiving, using a communication device, at least one space indicator from at least one external database.

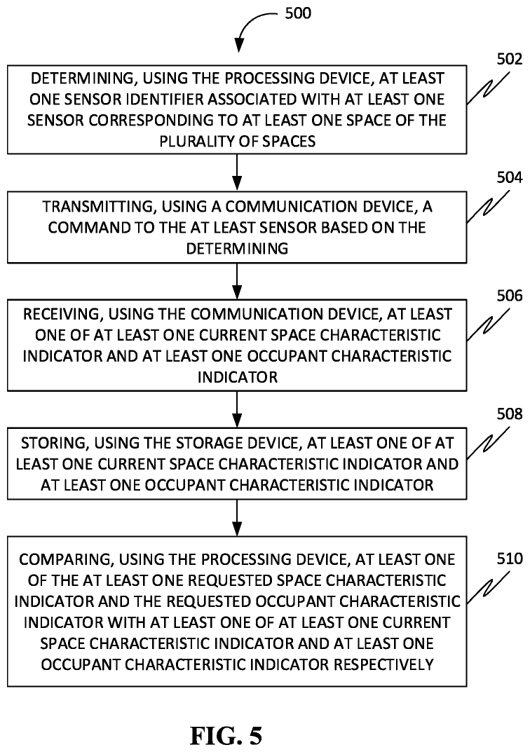

FIG. 5 is a flowchart of a method 500 of obtaining sensor information in accordance with some embodiments. At 502, the method 500 may include determining, using the processing device, at least one sensor identifier associated with at least one sensor corresponding to at least one space of the plurality of spaces. Further, the determining may be based on the analyzing.

Further, at 504, the method 500 may include transmitting, using a communication device, a command to the at least one sensor based on the determining. Further, at 506, the method 500 may include receiving, using the communication device, one or more of at least one current space characteristic indicator and at least one occupant characteristic indicator. Further, at 508, the method 500 may include storing, using the storage device, one or more of at least one current space characteristic indicator and at least one occupant characteristic indicator. Further, at 510, the method 500 may include comparing, using the processing device, one or more of the at least one requested space characteristic indicator and the requested occupant characteristic indicator with one or more of at least one current space characteristic indicator and at least one occupant characteristic indicator respectively. Further, the retrieving may be based on the comparing.

In some embodiments, the at least one requested space characteristic indicator may include at least one indoor amenity indicator and at least one outdoor amenity indicator. Further, the at least one sensor may include at least one indoor sensor associated with the at least one indoor amenity and at least one outdoor sensor associated with the at least one outdoor amenity.

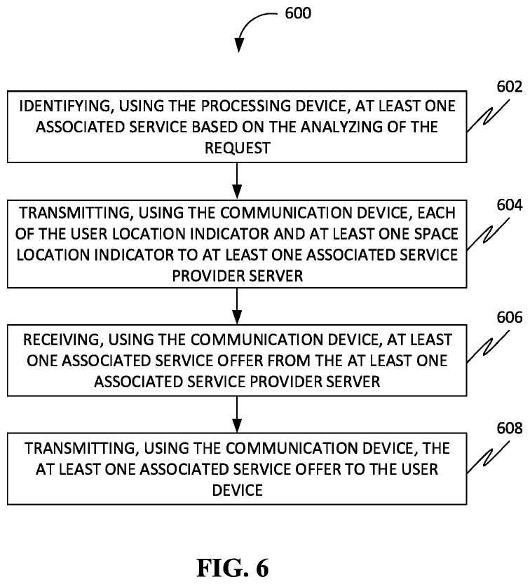

FIG. 6 is a flowchart of a method 600 of determining one or more associated services from one or more service providers in accordance with an exemplary embodiment. At 602, the method 600 may include identifying, using the processing device, at least one associated service based on the analyzing of the request. In some embodiments, the request may include an event indicator. Further, the identifying of the at least one associated service may be based on the event indicator. Further, the at least one associated service may include one or more of a ride sharing service, a public transportation service, a food delivery service and a laundry service.

Further, at 604, the method 600 may include transmitting, using the communication device, each of the user location indicator and at least one space location indicator to at least one associated service provider server. Further, the at least one space location indicator may be associated with at least one space of the plurality of spaces.

Further, at 606, the method 600 may include receiving, using the communication device, at least one associated service offer from the at least one associated service provider server.

Further, at 608, the method 600 may include transmitting, using the communication device, the at least one associated service offer to the user device.

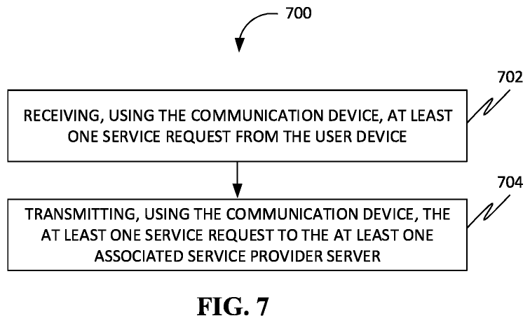

FIG. 7 is a flowchart of a method 700 of managing a service request in accordance with an exemplary embodiment. At 702, the method 700 may include receiving, using the communication device, at least one service request from the user device. Further, the at least one service request corresponds to the at least one associated service. Further, at 704, the method 700 may include transmitting, using the communication device, the at least one service request to the at least one associated service provider server.

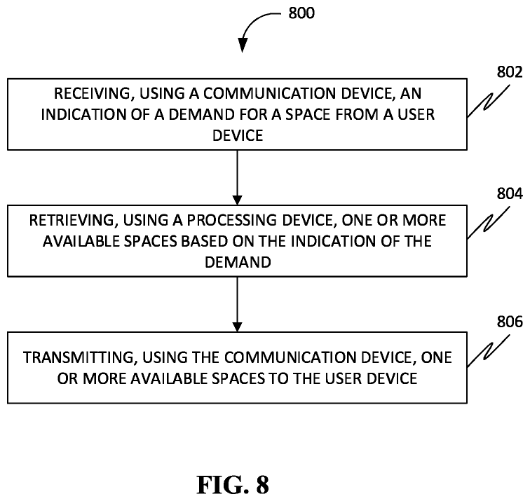

FIG. 8 illustrates a flowchart of a method 800 to facilitate searching of available spaces by a user, in accordance with the embodiments. At 802, the method 800 may include receiving, using a communication device, an indication of a demand for a space from a user device. Accordingly, the indication of demand may include a type of space that a user may be looking for. The type of space may include a house, an apartment, a hotel/motel room, a wedding venue, an office workspace and so on. For instance, the user may indicate that the user may be looking for a house or a space to host a wedding. Further, the indication may also include specific details about the space. For instance, if the user is interested in wedding spaces, the details include a total number of guests, wedding theme, and features of wedding spaces such as a terrace, a balcony, and so on. Further, the indication may also include a period of stay for which the user may be planning to use the space. In an instance, if the user is looking for a wedding space, the user may specify one or more dates for which the user may require the wedding space. Further, the indication may also include a location where the user may wish to search for the space, such as a location that the user may wish to visit, or where the user may wish host an event. The location may include a name of a city, a tourist spot, a street the, and so on. Further, the indication may include a filter corresponding to the location, such as a search radius. The user may indicate a search radius (such as 10 mile) corresponding to a landmark, such as a tourist spot. Accordingly, the user may be looking for one or more spaces within the radius. For instance, if the tourist spot is “The Statue of Liberty”, and the search radius is 10 miles, the user may be looking for one or more spaces within a 10-mile radius around “The Statue of Liberty”. In an instance, the indication of the demand may be received through an input mechanism of a user device such as, for example, a desktop computer, a laptop computer, a tablet computer, a mobile device, a smart home device, and a wearable device. Further, the user device may be configured to communicate with the communication device of a server computer. Accordingly, in an instance, the indication of the demand input through the input mechanism may be transmitted from the user device to the server computer. For instance, the user may provide the indication of the demand through a smart home device such as Amazon Echo® by using one or more voice commands. The one or more voice commands may include verbal words corresponding to one or more parameters such as the type of space, the period of stay, and the location, and so on.

Further, at 804, the method 800 may include retrieving, using a processing device, one or more available spaces based on the indication of the demand. For instance, information about the one or more spaces may be retrieved from one or more databases relevant to the indication. For instance, if the indication is related to home sharing, one or more home sharing application databases containing a list of one or more available home sharing spaces in an indicated location may be queried, and the relevant information corresponding to the one or more home sharing spaces may be retrieved. Further, relevant information corresponding to the one or more spaces may include a price, average customer rating, ambience, basic amenities (such as water supply, power supply, internet accessibility) and so on. In another instance, the indication may be related to a wedding space. Accordingly, one or more databases containing a list and details of one or more wedding spaces in a location included in the indication of demand may be queried and the relevant information corresponding to the one or more wedding spaces may be retrieved. The relevant information corresponding to the one or more wedding spaces may include a wedding theme, venue style, number of guests that the one or more wedding spaces may be appropriate to host, and so on. In another instance, the indication may be related to a conference room. Accordingly, databases housing a list of conference rooms, such as websites of hotels may be queried, and information about one or more available conference rooms along with details such as location, capacity, facilities available, and so on, may be retrieved. Further, in another instance, the indication may be related to hotel rooms. Accordingly, hotel databases may be queried to retrieve information about one or more hotel rooms, along with additional information such as one or more amenities available. Further, in an instance, based on information received in the indication of demand, one or more hotels and hotel rooms where celebrities, such as sportspersons, movie actors and so on may have previously stayed may be retrieved.

Further, at 806, the method 800 may include transmitting, using the communication device, one or more available spaces to the user device. For instance, a list of spaces for home sharing, retrieved from home sharing databases, a list of wedding venues retrieved from wedding venues databases, or a list of conference rooms may be transmitted to the user device.

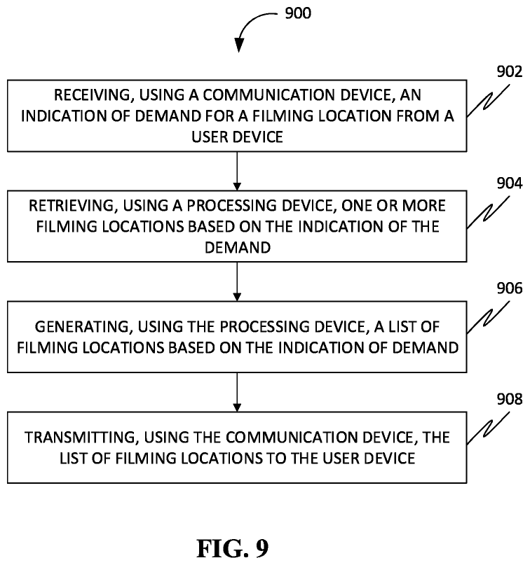

FIG. 9 illustrates a flowchart of a method 900 to display one or more filming locations to a user, in accordance with some embodiments. Accordingly, at 902, the method 900 may include receiving, using a communication device, an indication of demand for a filming location from a user device. The indication may include a location where the user may wish to film. The location may include the name of a city, a country, a tourist spot, name of a filming location, and so on. The tourist spots may include a famous monument such as the “Eiffel Tower”. The filming location may include the name of a movie set. The indication may also include the name of a movie. The name of the movie may indicate one or more places where the particular movie may have been shot. The one or more places may include the name of buildings, cities, beaches, and so on. The indication may also include the time-period for which the filming location may be required. The time-period may refer to one or more days, weeks or months. Further, the indication of demand may include additional details about the type of filming location that the user may require. In an instance, the additional details may be received through one or more appropriate filters. For instance, the filters may include a type of location, such as agricultural farms, airports, auditoriums, beaches, bars, casinos, hospitals and so on. The filter may also include a budget range of the user. Further, the filter may also include prop availability.

At 904, the method 900 may include retrieving, using a processing device, one or more filming locations based on the indication of the demand. Accordingly, one or more databases containing information about filming locations may be queried. For instance, if the user is looking for a filming location in Paris, then one or more databases offering filming locations in Paris may be queried, and relevant information related to the one or more filming locations may be retrieved. In another instance, if names of one or more movies may have been included in the indication, relevant databases, such as databases storing information about the specific one or more movies may be queried to retrieve information about one or more locations where specific one or more movies may have been filmed.

Further, at 906, the method 900 may include generating, using the processing device, a relevant list of filming locations based on the indication of demand. The one or more filming locations retrieved from the database may be arranged on the basis of relevance. For instance, the filming locations may be arranged in descending order of a number of times that the filming locations may have been used for filming. Further, the filming locations may be arranged on the basis of one or more filters, such as ascending, or descending order of price. Accordingly, the filming locations may be sorted in the ascending order of the budget, i.e., the filming location with low rental charge may appear above the filming location with high rental charge, or vice versa.

Further, at 908, the method 900 may include transmitting, using the communication device, the list of filming locations to the user device. The one or more filming locations may be transmitted to the user device, and may be transmitted in the form of the generated list.

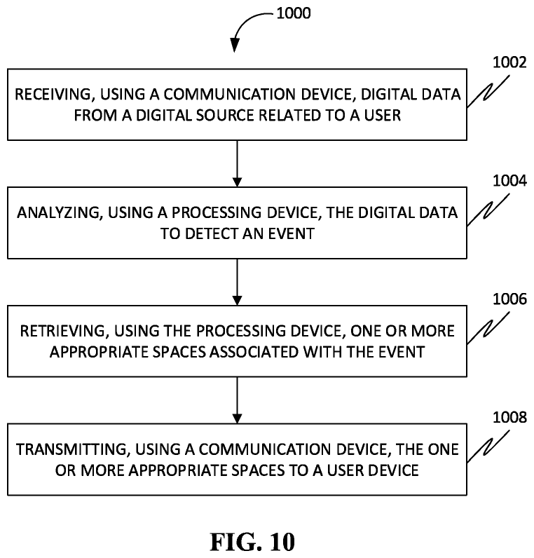

FIG. 10 illustrates a flowchart of a method 1000 to identify an event and display one or more appropriate spaces, in accordance with some embodiments. At 1002, the method 1000 may include receiving, using a communication device, digital data from a digital source related to a user. The digital source may include a calendar application in a smartphone of the user. The digital data received from the calendar may include data related to one or more business meeting, birthdays, anniversaries, and so on. The digital source may also include a social media platform such as Facebook®. The received digital data from the digital source may include events such as a concert, a marathon, a meeting, and so on that the user may be attending. For instance, if the user has checked in for a specific event on a social media website, the digital data related to that event may be received. The digital source may also include an email account of the user, such as Gmail®, Outlook®, Yahoo®, and so on. Further, the digital data received from the email account of the user may include data from one or more emails, such as online ticket confirmations, meetings, concert passes, and so on. Further, at 1004, the method 1000 may include analyzing, using a processing device, the digital data to detect an event. The digital data may be analyzed to extract information about one or more events. For instance, data from a calendar application of the user may be analyzed to determine an upcoming event, such as an office meeting and/or a market research meeting, and additional details, such as a number of participants of the event, and a date and time of the event. Further, in an instance, digital data from a social media platform may be analyzed to detect one or more future events that the user may be interested in or going to, such as such as a concert, an exhibition and so on. The analyzing may also determine a time and location of the event. The time may also indicate a duration of the event and a time when the event may start. The location may include the name of the city, area or building where the event may take place. Further, in an instance, digital data from an email account of the user may be analyzed to determine one or more events that the user may be attending. For instance, the email account of the user may include confirmed ticket reservations corresponding to a music festival, a sports event, and so on, along with additional details such as a date, time, and location of the event.

Further, at 1006, the method 1000 may include retrieving, using the processing device, one or more spaces associated with the event. For instance, if the digital data is associated with an upcoming office meeting and/or the market research meeting, then one or more relevant databases housing a list of available conference rooms, such as hotel databases may be queried, and one or more appropriate conference rooms based on a number of members participating in the meeting, appropriate location, and so on may be retrieved. In another instance, the digital data may be associated with a concert. Accordingly, hotels and/or room sharing databases in the proximity of the concert may be queried. Further, if the digital data (such as group conversations, email threads, and so on) corresponds to a possible band rehearsal, information about appropriate spaces for band rehearsals, such as music studios, garages, community centers, may be retrieved from one or more appropriate databases, such as space sharing databases.

Further, at 1008, the method 1000 may include transmitting, using a communication device, the one or more appropriate spaces to a user device. The one or more appropriate spaces retrieved from the databases may be transmitted to a user device, such as a smartphone, laptop computer, desktop computer, and so on. For instance, a list of conference rooms, hotel rooms, studios, and so on may be transmitted based on the event that the user may be interested in or going to.

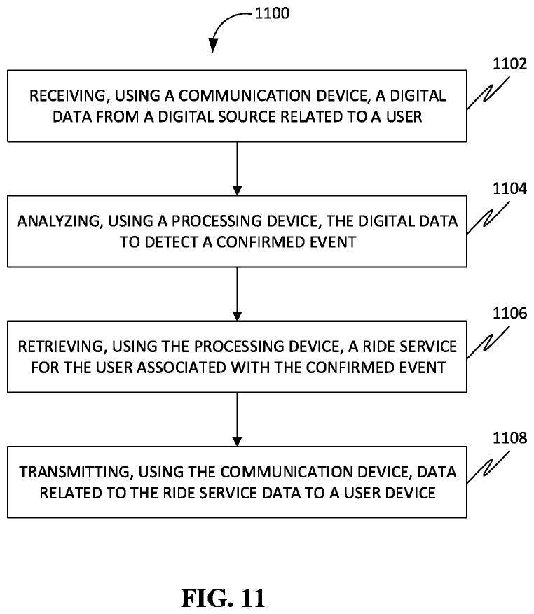

FIG. 11 illustrates a flowchart of a method 1100 to facilitate the user to procure a ride service based on a detected confirmed event, in accordance with some embodiments. Further, at 1102, the method 1100 may include receiving, using a communication device, a digital data from a digital source related to a user. The digital source may include a calendar application in a smartphone of the user. The digital data received from the calendar may include data related to one or more business meeting, birthdays, anniversaries, and so on. The digital source may also include a social media platform such as Facebook®. The received digital data from the digital source may include events such as a concert, a marathon, a meeting, and so on that the user may be attending. For instance, if the user has checked in for a specific event on a social media website, the digital data related to that event may be received. The digital source may also include an email account of the user, such as Gmail®, Outlook®, Yahoo®, and so on. Further, the digital data received from the email account of the user may include data from one or more emails, such as online ticket confirmations, meetings, concert passes, and so on.

Further, at 1104, the method 1100 may include a, using a processing device, the digital data to detect a confirmed event. A confirmed event may include the online ticket reservation to the air flight, a hotel reservation, a concert pass, and so on, as received from an email account of the user. For instance, an online ticket reservation corresponding to an airplane ticket may be used to extract information such as boarding time, a name of the airport, and so on.

Further, at 1106, the method 1100 may include retrieving, using the processing device, a ride service for the user associated with the confirmed event. For instance, if the confirmed event is an online ticket reservation corresponding to a concert, data related to the event, such as a time and location may be user to provide a ride service to the user. Further, the data associated with the confirmed event may include a reservation made in association with the confirmed event. For instance, if the confirmed event is a concert, a hotel room may have been reserved in a city of the concert on the date of the concert. Further, one or more ride-sharing service databases may be queried to retrieve one or more potential rides for the user. The ride-sharing services may be queried to retrieve a ride based on concert timings. The ride may be from a location of the user, such as a location where the user may be staying, user location to the concert location and vice versa.

Further, at 1108, the method 1100 may include transmitting, using the communication device, data related to the ride service to a user device. The ride service data of the one or more rides retrieved from the ride-sharing databases may be transmitted to a user device, such as a smartphone, a desktop computer, a laptop computer, and so on. The ride service data may include data such as ride service provider, pick up time, an average rating of the driver, estimated fare, estimated travel time, and so on. Further, in an embodiment, a travel itinerary may be generated and transmitted to the user device. The travel itinerary may include information related to the ride service, and information related to the confirmed event, such as a sports event.

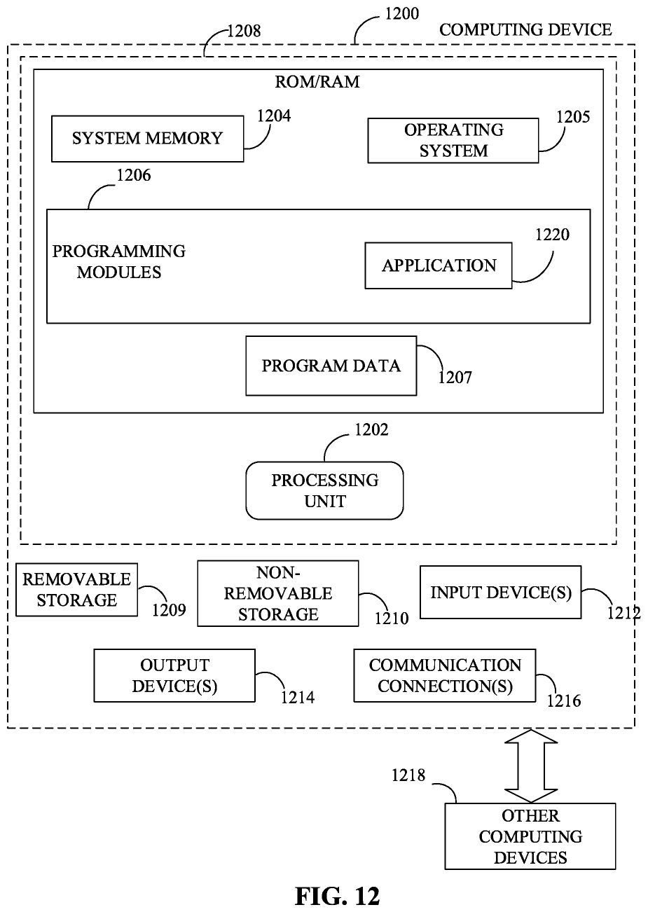

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination.

System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method of facilitating management of a plurality of spaces based on at least one space characteristic and at least one occupant characteristic, the method comprising:
providing a communication device;
providing a processing device;
providing a storage device;
receiving, using the communication device, a request from a user device, wherein the request comprises at least one requested space characteristic indicator and at least one requested occupant characteristic indicator;
receiving, using the communication device, a user location indicator from the user device, wherein the user device comprises a location sensor configured for generating the user location indicator based on a location of the user device;
analyzing, using the processing device, the request and the user location indicator;
retrieving, using the storage device, a plurality of space indicators corresponding to a plurality of spaces based on the analysis, wherein the plurality of spaces comprises a space with a paid shuttle and bar bus info or a free shuttle and bar bus info to an event and a space with bike rental and a home;
transmitting, using the communication device, the plurality of space indicators to the user device;
identifying, using the processing device, at least one associated service based on the analysis of the request, wherein the at least one associated service comprises a supplementary service, wherein the supplementary service comprises at least one of a ride sharing service, a bar bus transportation service, a food delivery service, a hangover/IV service and a laundry service;
transmitting, using the communication device, each of the user location indicator and at least one space location indicator to at least one associated service provider server, wherein the at least one space location indicator is associated with at least one space of the plurality of spaces;
receiving, using the communication device, at least one associated service offer from the at least one associated service provider server; and
transmitting, using the communication device, the at least one associated service offer to the user device.

2. The method of claim 1 further comprising:
transmitting, using the communication device, the request to a plurality of external databases, wherein each external database is configured for storing data representing the at least one space of the plurality of spaces; and
receiving, using the communication device, the at least one space indicator from at least one external database.

3. The method of claim 1 further comprising:
determining, using the processing device, at least one sensor identifier associated with at least one sensor corresponding to at least one space of the plurality of spaces, wherein the determination is based on the analysis;
transmitting, using the communication device, a command to the at least one sensor based on the determination;
receiving, using the communication device, at least one of at least one current space characteristic indicator and at least one occupant characteristic indicator;
storing, using the storage device, at least one of at least one current space characteristic indicator and at least one occupant characteristic indicator; and
comparing, using the processing device, at least one of the at least one requested space characteristic indicator and the requested occupant characteristic indicator with at least one of at least one current space characteristic indicator and at least one occupant characteristic indicator respectively, wherein the retrieve is based on the comparison.

4. The method of claim 3, wherein the at least one requested space characteristic indicator comprises at least one indoor amenity indicator and at least one outdoor amenity indicator, wherein the at least one sensor comprises at least one indoor sensor associated with the at least one indoor amenity and at least one outdoor sensor associated with the at least one outdoor amenity.

5. The method of claim 1, wherein the request comprises an event indicator, wherein the method further comprises identifying, using the processing device, an event location based on the event indicator, wherein retrieving the plurality of space indicators is further based on the identification of the event location.

6. The method of claim 5, wherein the event indicator is associated with a calendar appointment corresponding to the user device, wherein the calendar appointment further comprises an event time indicator, wherein retrieving the plurality of space indicators is further based on the event time indicator.

7. (canceled)

8. The method of claim 1 further comprising:
receiving, using the communication device, at least one service request from the user device, wherein the at least one service request corresponds to the at least one associated service; and
transmitting, using the communication device, the at least one service request to the at least one associated service provider server.

9. The method of claim 1, wherein the request comprises an event indicator, wherein the identification of the at least one associated service is further based on the event indicator.

10. The method of claim 1, wherein the request further comprises a theme indicator associated with a theme, wherein retrieving the plurality of space indicators is further based on the theme indicator.

11. A system for facilitating management of a plurality of spaces based on at least one space characteristic and at least one occupant characteristic, the system comprising:
a communication device;
a processing device; and
a storage device;
the system being configured for:
receiving, using the communication device, a request from a user device, wherein the request comprises at least one requested space characteristic indicator and at least one requested occupant characteristic indicator;
receiving, using the communication device, a user location indicator from the user device, wherein the user device comprises a location sensor configured for generating the user location indicator based on a location of the user device;
analyzing, using the processing device, the request and the user location indicator;
retrieving, using the storage device, a plurality of space indicators corresponding to a plurality of spaces based on the analysis, wherein the plurality of spaces comprises a space with a paid shuttle and bar bus info or a free shuttle and bar bus info to an event and a space with bike rental and a home;
transmitting, using the communication device, the plurality of space indicators to the user device;
identifying, using the processing device, at least one associated service based on the analysis of the request, wherein the at least one associated service comprises a supplementary service, wherein the supplementary service comprises at least one of a ride sharing service, a bar bus transportation service, a food delivery service, a hangover/IV service and a laundry service;
transmitting, using the communication device, each of the user location indicator and at least one space location indicator to at least one associated service provider server, wherein the at least one space location indicator is associated with at least one space of the plurality of spaces;
receiving, using the communication device, at least one associated service offer from the at least one associated service provider server; and
transmitting, using the communication device, the at least one associated service offer to the user device.

12. The system of claim 11, wherein the system is further configured for:
transmitting, using the communication device, the request to a plurality of external databases, wherein each external database is configured for storing data representing at least one space of the plurality of spaces; and
receiving, using the communication device, at least one space indicator from at least one external database.

13. The system of claim 11, wherein the system is further configured for:
determining, using the processing device, at least one sensor identifier associated with at least one sensor corresponding to at least one space of the plurality of spaces, wherein the determination is based on the analysis;
comparing, using the processing device, at least one of the at least one requested space characteristic indicator and the requested occupant characteristic indicator with at least one of at least one current space characteristic indicator and at least one occupant characteristic indicator respectively, wherein the retrieve is based on the comparison;
transmitting, using the communication device, a command to the at least one sensor based on the determination; and
receiving, using the communication device, at least one of at least one current space characteristic indicator and at least one occupant characteristic indicator, wherein the storage device is further configured for storing at least one of at least one current space characteristic indicator and at least one occupant characteristic indicator.

14. The system of claim 13, wherein the at least one requested space characteristic indicator comprises at least one indoor amenity indicator and at least one outdoor amenity indicator, wherein the at least one sensor comprises at least one indoor sensor associated with the at least one indoor amenity and at least one outdoor sensor associated with the at least one outdoor amenity.

15. The system of claim 11, wherein the request comprises an event indicator, wherein the system is further configured for identifying, using the processing device, an event location based on the event indicator, wherein retrieving the plurality of space indicators is further based on the identification of the event location.

16. The system of claim 15, wherein the event indicator is associated with a calendar appointment corresponding to the user device, wherein the calendar appointment further comprises an event time indicator, wherein retrieving the plurality of space indicators is further based on the event time indicator.

17. (canceled)

18. The system of claim 11, wherein the system is further configured for:
receiving, using the communication device, at least one service request from the user device, wherein the at least one service request corresponds to the at least one associated service; and
transmitting, using the communication device, the at least one service request to the at least one associated service provider server.

19. The system of claim 17, wherein the request comprises an event indicator, wherein the identification of the at least one associated service is further based on the event indicator.

20. The system of claim 11, wherein the request further comprises a theme indicator associated with a theme, wherein retrieving the plurality of space indicators is further based on the theme indicator.
